(19) United States
(12) Patent Application Publication
(10) Pub. No.: US 2010/0185931 A1
(43) Pub. Date: Jul. 22, 2010

(54) SHIPPING SYSTEM FOR A CONSIGNMENT, AND METHOD FOR PROCESSING THE CONSIGNMENT

(75) Inventors: Boris Mayer, Bonn (DE); Thomas Ogilvie, Bonn (DE)

Correspondence Address: International IP Law Group, P.O. BOX 691927, HOUSTON, TX, 77269-1927, US

(73) Assignee: Deutsche Post AG, Bonn (DE)

(21) Appl. No.: 12/666,339

(22) PCT Filed: May 21, 2008
(86) PCT No.: PCT/EP08/04087

§ 371 Date: Dec. 23, 2009

(30) Foreign Application Priority Data
Jun. 26, 2007 (EP) 07012480.5

(51) Int. Cl. G06F 15/16; G06F 17/30; G06F 17/20

(52) U.S. Cl. 715/224; 709/203; 707/812

(57) ABSTRACT

There is provided a shipping system for at least one consignment. An exemplary shipping system comprises a first terminal for entering first data about the consignment, a detector that is adapted to acquire further data about the consignment and a consolidation server that stores, administers, processes and/or evaluates the first data, as desired. The exemplary shipping system also comprises a transmitter that is adapted to transmit the first data and the additional data to the consolidation server and a checker that is adapted to determine whether the additional data about the consignment was received. The exemplary shipping system additionally comprises a transmitter that is adapted to transmit the first data to a data recipient, the transmitter that is adapted to transmit the first data to the data recipient being configured so that it ascertains whether the additional data about the consignment was received so that the transmission of the first data only takes place once the additional data has been received.

### CROSS REFERENCE TO RELATED APPLICATIONS

Pursuant to 35 U.S.C. §371, this application is the United States National Stage Application of International Patent Application No. PCT/EP2008/004087, filed on May 21, 2008, the contents of which are incorporated by reference as if set forth in their entirety herein, which claims priority to European (EP) Patent Application No. 07012480.5, filed Jun. 26, 2007, the contents of which are incorporated by reference as if set forth in their entirety herein.

### BACKGROUND

Numerous regulations exist for clearing postal products within the scope of national and international customs agreement. For example, simplified clearing procedures exist for all postal products that fall under Article 237, 238 of ZK-DVO (Zollkodex Durchführungsverordnung—Regulation on the Implementation of the Customs Code). In this context, consignments above a certain value, whose contents are subject to customs duties have to be accompanied by a completely filled-in customs declaration for purposes of customs import and export processing. In most countries, electronic data transmission to the national customs authorities is currently not required. As a rule, up to a certain value limit, the customs declarations are made orally. At a higher value, a written or electronic customs declaration has to be made for every single consignment. Moreover, there are specific duty-free allowances for B2C consignments (Business-to-Consumer consignments) and B2B consignments (Business-to-Business consignments) as well as for C2C consignments (Consumer-to-Consumer consignments).

The customs authorities calculate the duties to be paid on the basis of the postal documents. In this process, it is often the case that the forms CN 22 and CN 23 which are designated for the customs declaration, do not contain sufficient information to serve as the basis for a proper customs clearance. Additional difficulties arise from the different languages used on the postal documents.

Furthermore, new objectives have been established worldwide by the customs authorities: in addition to fiscal the aspects of customs controls, safety-relevant considerations also come to the fore. The more stringent safety requirements call for special risk management. There are also statutory changes in postal traffic such as, for example, the elimination of duty-free allowances for consignments and the elimination of oral customs declarations. Moreover, ever-greater globalization is being pursued, for example, by harmonizing statutory stipulations for postal organizations and express service providers on an international level. Furthermore, there is a desire for a worldwide operative exchange of customs information for postal products as well as greater transparency in postal traffic and in the provision of electronic information for performing risk analyses.

### SUMMARY OF THE INVENTION

Exemplary embodiments of the present invention relate to a shipping system for at least one customs-relevant consignment, and to a method for processing data that is generated in a shipping system for at least one consignment.

A shipping system according to an exemplary embodiment of the present invention may comprise:
a first terminal for entering the first data about the consignment,
a detection means for acquiring additional data about the consignment,
a consolidation server that stores, administers, processes and/or evaluates the first data, as desired,
a means for transmitting the first data to the consolidation server,
a means for transmitting the additional data to the consolidation server,
a means for jointly forwarding the first data, whereby this means is configured in such a way that an evaluation is carried out in order to ascertain whether the additional data was received and in such a way that a transmission of the first data to a data recipient is triggered once it has been ascertained that the additional data has been received.

The transmission of the first data to the data recipient can be triggered according to an exemplary embodiment of the present invention in various ways.

For example, it is possible to evaluate the receipt of the additional data.

Thus, for example, when the additional data about a consignment is received, it can be ascertained whether first data about this consignment is already on hand.

An association between the first data and the additional data may be carried out, for example, via a consignment identification number.

This association makes it possible to ascertain whether the additional data was received. The additional data can comprise various pieces of information such as, for instance, information about the mailpiece being dropped off, about the mailpiece being received at a processing center or its passing a detection location. In particular, the additional data can be so-called scan events.

However, by the same token, it is possible for the additional data to be supplementary information.

Thus, for example, if applicable, first data that might be incomplete can be replaced with additional data, for instance, with data about the consignment that was not filled in by the person who dropped off the mailpiece.

An exemplary embodiment of the present invention provides for a completeness check of the first data to be carried out in such a way that the generation of a postage indicium or its being dropped off for processing a shipping process is only made possible if the first data is complete. In this context, completeness of the first data means that all of the mandatory information called for here—for instance, about the sender, about the recipient of the consignment or about the contents of the consignment—has been entered.

An appropriate consignment sticker—for example, in the form of a printed sticker or in the form of a transponder containing information—may be applied. The transponder may comprise, for example, an RFID tag that contains the consignment identification number as the identifier.

In an exemplary embodiment of the present invention, the shipping system may comprise a communication device for receiving the first data.

The first terminal may comprise a user terminal

In another exemplary embodiment of the present invention, the first terminal comprises an automated acquisition terminal.

Moreover, a shipping system according to an exemplary embodiment of the present invention may comprise a printer for printing the first data.

The printer may comprise, for example, a laser printer, an inkjet printer or a thermal transfer printer that can print the consignment or that can print a sticker (for example, a label or a sheet of paper) that can be attached to the consignment.

An exemplary shipping system may comprise a storage device for storing data in the transponder. The storage device may comprise, for example, a transmitter for electromagnetic waves, that can be controlled by a suitable computer unit—if applicable, a user computer or a server.

The storage device can contain the first data—especially data about the content of the consignment, about its weight, about a recipient or about a sender.

Furthermore, exemplary embodiments of the present invention may comprise a method for processing the consignment as well as a method for processing data that is used in a shipping system.

First data about the consignment may be acquired in a first terminal

The first terminal can be, for example, a user terminal.

There may be various ways and/or places to acquire the first data.

For instance, the first data can be acquired in the area of the user terminal—for example, a user computer. This is done, for instance, by using an input means of the computer and, if applicable, by utilizing a graphic user interface (GUI) of the computer.

Exemplary embodiments of the invention provide for the first data to be transmitted physically as well as electronically.

The first data may be physically applied to the mailpiece—for instance, by printing on the consignment, by applying a sticker onto the consignment or by attaching a transponder onto the consignment.

In addition, the first data is transmitted electronically, for example, to a network node or server.

Moreover, first data can be acquired in the area of a drop-off station for the mailpiece.

The first data may be stored in a storage medium that can be attached to the consignment such as, for example, a transponder.

The consignments may be dropped off at a logistics system and that at least one processing step that takes place in the logistics system is carried out as a function of the first data.

An exemplary embodiment of the method, of the information carrier, of the consignment and of the device provides that the information carrier can be attached to an object that is to be shipped.

In an exemplary embodiment of the present invention, the objects that are to be shipped as the consignment provides that they have a surface on which consignment information can be written and/or that they have an information carrier for storing acquired graphic information.

An exemplary embodiment of the method, of the information carrier, of the consignment and of the device provides that the consignment information is ascertained, at least in part, by an evaluation of the acquired graphic information.

In an exemplary embodiment of the invention, a transmitter emits electromagnetic signals that can be received by the storage medium.

The first data refers especially to individual or several of the following pieces of information: sender, invoice recipient, recipient, contact person of the sender, of the recipient or of the invoice recipient and/or information about the contents and/or the value of the consignment.

Exemplary embodiments of the invention can be carried out with various types of devices and is thus not limited to specific devices.

The term logistics system is to be understood in a broad sense. In particular, it comprises systems that encompass the means and devices to carry out the transport of consignments from drop-off locations to delivery locations on a transportation route, preferably within a postal distribution network.

An exemplary embodiment of the method, of the device, of the container and of the logistics system is characterized in that the first data is stored and/or transmitted by a device for accepting the objects that are to be transported (consignment).

This makes it possible, for example, when the consignment is dropped off, to ascertain and, if applicable, to transmit information about the drop-off procedure—especially for tracing purposes—or to store it—for example, for tracking purposes.

Furthermore, it may be advantageous for the first data to be stored and/or transmitted by an interaction with the device.

An exemplary embodiment of the method, of the device, of the container and of the logistics system provides for the information storage unit to be connected to the object that is to be transported.

In an exemplary embodiment of the method, of the device, of the container and of the logistics system the information storage unit contains an identifier.

An exemplary embodiment of the method, of the device, of the container and of the logistics system provides for the identifier to identify the object that is to be transported.

An exemplary embodiment of the method, of the device, of the container and of the logistics system may be characterized in that the information storage unit is permanently affixed to the object that is to be transported.

An exemplary embodiment of the method, of the device, of the container and of the logistics system provides that information about at least one consignment is acquired, whereby the information is associated with a consignment.

An exemplary embodiment of the method, of the device, of the container and of the logistics system may be characterized in that the acquired information consists of one or more codes that identify the consignment or consignments.

In this manner, it may be possible to improve the tracking and/or tracing of the consignments in a simple and reliable manner.

an exemplary embodiment of the present invention improves logistical functions. Moreover, such an exemplary embodiment provides a logistics system that allows tracking and tracing for numerous consignments.

Exemplary embodiments of the invention make the first data available directly at the drop-off location, thereby speeding up the processing of the objects that are to be transported as the consignment.

The delivery location may be selected by the person ordering the transport. In case of returns, this is, for example, the warehouse of a merchant or manufacturer.

An exemplary embodiment of the method, of the device, of the container and of the logistics system provides that a person picking up the consignments terminates the entire drop-off procedure by selecting a function to this effect on an input means.

An exemplary embodiment of the method, of the device, of the container and of the logistics system is characterized in that the input means is a mobile user terminal.

It is advantageous to use the drop-off data acquired according to an exemplary embodiment of the invention—as a component of the first data—in order to control logistical procedures in the logistics system.

An exemplary embodiment of the invention provides for at least one processing operation in the logistics system to be carried out as a function of the first data.

Thus, for instance, it is possible to regulate capacities in processing centers for the consignments—especially mail or parcel centers—as a function of the first data.

The objects to be transported are, for example, various types of objects that are each associated with certain process steps. In typical logistics systems, for example, in the postal sector, parcels or packages are associated with identification means such as codes (Identcodes) so that the route of a particular consignment can be controlled and tracked as efficiently as possible. Normally, such a code has to be detected by detection means when a consignment is deposited. For instance, a postal number in the form of a scanned-in code or a character string entered via a keyboard is detected.

During the detection of the identification numbers that identify the consignments, it is also possible to encounter consignments that have additionally been provided with a special Identcode that likewise has to be scanned in when such consignments are accepted. Moreover, these can be C.O.D. consignments with C.O.D. amounts that have to be entered or any other kinds of special consignments that involve additional steps.

An exemplary embodiment of the method, of the logistics system, of the container and of the computer program product provides that the reading unit or a data processing unit connected to it evaluates the first data.

An exemplary embodiment of the method, of the logistics system, of the container and of the computer program product is characterized in that the first data is stored.

An exemplary embodiment of the method, of the logistics system, of the container and of the computer program product provides for the first data to be stored in the storage medium.

An exemplary embodiment of the method, of the logistics system, of the container and of the computer program product is characterized in that the first data is stored in the reading unit and/or in the data processing unit that is connected to the reading unit.

An exemplary embodiment of the invention provides for the data processing unit to carry out an evaluation of the first data.

An exemplary embodiment of the method, of the logistics system, of the container, of the transport means and of the computer program product is characterized in that at least one handling procedure involving the container is carried out as a function of the evaluation.

Many types of information carriers such as shipping stickers and transponders are suitable for use according to the invention.

Special preference is given to the use of information carriers that are provided with at least one identifier. Transponders with identifiers are also referred to below as RFID tags.

An RFID tag consists, for example, of a microchip and an antenna. A code is stored on the microchip and this code contains the first data and/or other processing-relevant information. In particular, this information comprises identifiers.

Transponders are configured in such a way that, in response to a triggering (radio) signal from a reading device, they themselves emit and/or receive signals. Active transponders contain an energy supply for their operation. In contrast, passive transponders obtain their energy from the signals emitted by the reading device.

The technical implementation of the invention preferably comprises a database containing information about the consignments to be transported.

An exemplary embodiment of the invention is characterized in that the position of the object is determined by a location finder that is connected to the object (the consignment), and in that the position of the object is associated with the obtained first data. In this context, the position of the object can be determined by a location finder directly on the object or on a transport means with which the object is being transported. If the location finder is on an associated transport means, it is preferably in communication with the data processing unit of the object.

The position of the object can be determined, for example, by a location finder in the form of a GSM module, a GPS module and/or a direction-finding transmitter. The various location finders can be used here as a function of the required precision of the position determination, whereby they can be used either perpendicularly or in parallel.

A reading unit, for example, a code reader or an antenna, can be provided as a detector for the consignment. The consignments are registered in that information carriers that are located on the consignments are read out when the information carrier (storage medium) connected to the consignment is moved past the reading unit during a drop-off procedure of the consignment.

The reading unit can also be equipped with a bulk detection device that detects the consignments once all of the consignments have been placed into a container.

During the consignment detection, at least the number of consignments placed into the containers is registered in the data processing unit. In this process, an object removed from the container reduces the number of consignments detected in the data processing unit, whereby the procedure of dropping off a consignment that has been taken out of the container is registered by detecting the number of procedures on the basis of the unambiguously identifiable RFID tag associated with the object.

Moreover, through the connection with a central data processing unit, information about the objects can be updated in the database and the operation of the device can be adapted to changing requirements.

The first data is preferably electronically relayed after the receipt of the additional data.

The storage and/or the transmission of the additional data is especially advantageous in order to achieve one or more of the following results:
proof that the consignment was accepted;
transmission of the point in time of the drop-off of the consignments taken from the device (for tracking the dropped-off consignments) and/or storage of the point in time of the drop-off of the consignments taken from the device (for tracing the dropped-off consignments).

Such information constitutes especially preferred examples of additional data according to the invention.

In addition to information that a consignment has been dropped off or detected, it is also possible for other information to be a component of the additional data and to be acquired as additional data and, if applicable, transmitted and/or stored.

An exemplary embodiment of the method, of the logistics system, of the container, of the transport methodology and of the computer program product is characterized in that a position of the consignment is determined.

An exemplary embodiment of the method, of the logistics system, of the container and of the computer program product provides that the position of the consignment is stored.

An exemplary embodiment of the method, of the logistics system, of the container, of the transport methodology and of the computer program product is characterized in that the position of the consignment is stored in a data processing unit.

An exemplary embodiment of the method, of the logistics system, of the container and of the computer program product provides that the position of the consignment is determined and that the position of the consignment is associated with the received first data and/or the second data.

The following three modalities for acquiring the first data are especially preferred:

The first modality relates to the acquisition in the area of a user computer, another modality relates to the acquisition in the area of a drop-off location. The third modality for the acquisition of the first data is the acquisition in the area of a processing unit—for example, in a shipping center.

During the acquisition of the first data, for example, in a shipping center, a decentralized preparation of the consignment in terms of its being ready for customs clearance can be carried out, insofar as this is not possible in the first two acquisition options (user computer, drop-off location). In this manner, the data does not have to be acquired centrally in an international freight station where the customs clearance is prepared, but rather, it is ensured that all of the consignments are already prepared when they arrive at the international freight station, regardless of where the first data was acquired, so that there only the second data has to be acquired and no additional processing steps (special processes) are necessary.

Consequently, the first data can be entered either by the customer (user computer or terminal at the drop-off location) or by employees of the logistics service provider (postal companies) in one or more central data detection locations.

If applicable, this information can be linked to information about the consignment.

An example of information about the consignment is the information indicating that the consignment has been detected, the place of detection of the consignment or the time of the detection of the consignment.

An exemplary embodiment of the invention comprises various modalities of acquisition of the additional data about the consignment, for example, at a drop-off location or in a data acquisition unit in a consignment processing center—for example, in a mail center, a parcel center or a freight center.

In an exemplary embodiment of the invention, the additional data comprises detection data about the consignment. The detection data is filed when the consignment is detected. This data contains one or more of the following items of information:

Examples of the detection data include status information about the consignment. The status information can be, for example, an indication that a consignment was present at a detection location. However, the detection data can also contain a great deal of more in-depth information, for instance, about the current location of the consignment, about its condition or about its state. This is, for example, information that makes it possible to determine the status of the consignment. If applicable, along with this information, additional information can be incorporated into the detection data, for instance, about the integrity of the consignment and/or about the absence of damage to the contents.

The information about the integrity of the consignment comprises especially information that the consignment has not been opened or modified.

This information is very advantageous for controlling the processing of the consignment. For example, it is possible to carry out a method for transporting and/or sorting the consignment in such a way that a consignment for which a change in its condition or state has been ascertained will be ejected from the transport process of the consignments.

In this manner, for example, consignments for which there could be a risk that impermissible objects were added after they were dropped off can be ejected from the transport process of the consignments.

The term “detection” encompasses numerous implementation possibilities, for instance, an identification of a consignment or of an information carrier that accompanies the consignment (for example, a delivery note).

This makes it possible to increase the processing speed of the consignment.

When the additional data is present and/or when the additional data is received, the first data is transmitted (optionally with some or all of the additional data).

It is especially advantageous to use a trigger, for example, a database trigger.

The receipt of the additional data can be considered as an event.

An event serves, for example, to control a program flow. Predefinable event handling routines (listener, observer, event handler) are carried out when a certain event occurs, especially when the additional data is received.

This is done, for example, by a hard-wired circuit, a memory-implemented circuit or a data processing unit. The data processing unit can be programmed by means of suitable software routines. For instance, event-oriented programming can be combined very well with the concepts of object-oriented programming: objects then no longer define only properties and methods, but also event sources, and they offer the possibility to influence the event handling. Here, it is possible to model the event handling routines (event handlers) as objects.

In the case of certain kinds of events, especially editing (e.g. INSERT, UPDATE, DELETE in SQL) data in a table, a stored program is opened, which executes the further procedures.

Triggers are used, among other things, to maintain data consistency (integrity checks) and for inserting, deleting or modifying reference data. The trigger is carried out before the editing of the referenced table or else after it, as desired.

Since triggers themselves can insert, modify and delete data records, a trigger can initiate additional triggers when it is executed. This makes a further automation of processing steps possible.

Such processing steps are, for example, the forwarding of the first data and/or of the second data to an appropriate recipient, for example, the processing computer of a customs office.

An exemplary embodiment of the shipping system according to the invention comprises a first user terminal for the input of the first data.

An exemplary embodiment of the shipping system according to the invention comprises a processing center with an additional user terminal for the input of the additional data.

An exemplary embodiment of the shipping system according to the invention comprises a server that, as desired, stores, administers, processes and/or evaluates the data about a consignment stemming from the first and additional user terminal.

An exemplary embodiment of the shipping system according to the invention comprises a communication device that is connected to the first user terminal, if applicable, to the additional user terminal and to the server, and each time, it converts the data in such a way that the data of the first user terminal and, if applicable, the data of the second user terminal as well as the data of the server are compatible with each other.

An exemplary embodiment of the shipping system according to the invention comprises a communication device, whereby the communication device comprises one or more interfaces to at least one additional shipping system and/or to an additional data processing system.

It is advantageous for not only read-in information about a consignment but also previously stored information about the consignment to be forwarded to a receiving station. Since the information about the consignment is present in two components, namely, a component on the consignment itself and another component in a central database, the reading and processing work involved in processing a consignment is reduced.

This is very advantageous, for example, for printing an online label for the consignment. The online label is printed directly at the customer's premises or at a branch-office terminal. The data acquired in this manner is sent to a central database, where it can be read out again by using the Identcode of the consignment. This means that there is no need for another acquisition of the data later on when the consignment is dropped off and sorted in a mail center.

It is advantageous to forward the first data to an intended data recipient. This data is stored information about the consignment and/or about the sender of the goods. An example of a preferred recipient is a central computer of the pertinent customs authorities to which this information is transmitted.

In this way, information that is relevant for a consignment to clear customs can be transmitted to a server at a point in time that is independent of the actual shipping of the goods. Moreover, the acquisition of electronic customer data speeds up the clearing processes and ensures an improvement in the data quality for the customs clearance. Thus, using an electronic data processing system, it is possible to check the provided information for completeness. Moreover, as a function of the information, secure transport means and/or containers can be provided for the consignment.

The shipping system according to the invention is capable of sending and receiving various message formats. Moreover, it is possible to freely expand a platform provided by the shipping system, for example, for the exchange of customs information, provided in Germany by ARGUS. Thus, customers can be integrated individually or via consolidating pre-systems, and so can various service providers in the shipping sector and agencies such as, for example, various national or international customs authorities.

The shipping system according to an exemplary embodiment of invention can handle large shipping volumes. The potential exists for several million consignments per year.

The interface preferably connects to data processing systems at further so-called “authorized economic operators”. It is a prerequisite for an authorized economic operator to observe the customs regulations, especially electronic advance notification obligations pertaining to import and export, while complying with specific time requirements. Moreover, financial solvency has to be demonstrated and proper bookkeeping is to be ensured, especially through the use of a system for filing commercial and transportation documentation. Moreover, suitable safety measures have to be taken that minimize the risk in the international movement of goods, especially within the scope of standardized EU-uniform risk management.

In this manner, a very effective shipping system with the so-called “authorized economic operators” that meet the above-mentioned prerequisites can be installed.

In an exemplary embodiment of the present invention, submitting documentation to the customs authorities pertaining to a consignment and dropping off the consignment itself at a parcel service provider can take place completely independently of each other in terms of time and location. Thus, the various shipping clearance modules can be carried out flexibly and independently of each other both for import and export transactions.

For import procedures, these include, for example, the modules “submitting summary documentation to a customs office”, “submitting a customs declaration to a customs office”, “physical arrival in the customs region of the EU”, and “presentation of the goods at a customs office”.

For export procedures, the modules are, for example, “submitting summary documentation to an export customs office”, “submitting a customs declaration to the competent export customs office”, “transporting a consignment outside of the external EU borders”, “presentation of the goods at the competent customs office” as well as “inspection of a consignment at a competent export customs office”.

In an exemplary embodiment of the shipping system, it is provided for the additional shipping system and/or for the additional data processing system to be a national or international customs clearance system. An example of a national customs clearance system is ATLAS, the automated tariff and local customs clearance system in Germany. An example of an international customs clearance system is MEDICI, the acronym for “Mails Electronic Data Interchange & Customs Integration”.

Another exemplary embodiment of the shipping system provides for the additional shipping system and/or for the additional data processing system to be a customs clearance system that is adapted to the user. This is, for example, a system such as CURARE, which stands for “Customs Reorganization and Redesign”. The system ensures the cost-effectiveness and statutory conformity of the international business for a company for the customs clearance of postal consignments. In this manner, identification of a consignment, risk minimization, statutory conformity and performance are all ensured while defined quality criteria are observed.

Through the integration of the shipping system according to an exemplary embodiment of the invention in the manner described above, it is possible to monitor compliance with EU-uniform risk criteria. A risk evaluation for a shipping clearance process can be carried out as a function of the degree of compliance with the stipulated customs law, and errors on the part of an authorized economic operator in one country then can have a direct effect on the customs clearance in another country.

For a company, it has proven to be especially advantageous if it is possible to submit an electronic customs declaration for consignments. A declaration is not required for letters, postcards, printed matter, free mail for the blind and the like. Moreover, there can be a provision for simplified electronic declarations for duty-free consignments.

Another advantage of the shipping system according to an exemplary embodiment of the invention is that a legally binding power of attorney of the sender can already be granted online or at a first user terminal for the clearance of a consignment by the appertaining postal organization.

Moreover, at a user terminal, it can be provided that such a power of attorney or an already entered customs declaration for a consignment can once again be declared invalid.

Furthermore, the shipping system according to an exemplary embodiment of the invention allows incoming inspections and plausibility checks to be performed online or at the user terminal, for example, such as ascertaining whether a declaration is required for a consignment on the basis of a value limit Ascertaining the value limit can depend, for example, on whether it is a B2B, C2B or C2C consignment, which can be regulated by a user group concept.

The additional data processing system to which the shipping system according to an exemplary embodiment of the invention can be connected can be, for instance, stationary acquisition terminals, Internet applications for generating shipping documents or individual systems of large customers.

Another exemplary embodiment of the shipping system provides that the data about the consignment comprises information about the sender and about the recipient as well as customs-relevant information.

As a rule, such information, which is usually entered online or at a user terminal, comprises the value of a consignment, the country of origin, a description as well as a goods tariff number.

A customs content declaration contains especially the following information:
the name and address of the sender and of the recipient,
a precise designation of the content and quantity of the consignment,
the net weight of the individual objects as well as the total weight of the consignment, including the packaging,
the value of the individual objects as well as the total value of the consignment,
the type of consignment and
the data and signature of the sender.

For commercial goods, more detailed information is necessary, for example, a customs tariff number according to the “Harmonized Systems for the Designation and Encoding of Goods (HS)”, the country of origin of the goods, a commercial invoice or comparable document indicating the value of the goods.

An exemplary embodiment of the shipping system provides that an electronic form that has to be filled in by a user is available on the Internet or at the first user terminal. The data acquired there is transmitted using specified message formats (e.g. ITMATT—Item Attributes Message) to subsequent systems. ITMATT images the information contained in the forms CN 22 and CN 23 in such a way that an exchange between the various postal organizations is made possible.

In an additionally advantageous exemplary embodiment of the shipping system, the additional user terminal comprises a device for scanning the consignment or parts thereof, especially an Identcode that is applied onto the consignment, or else information that is applied onto or encoded in the consignment in some other manner, whereby the encoded data can be stored in the form of barcodes, RFID tags or other analog or digital data carriers. Thus, for example, when a consignment is dropped off as a postal shipment, the Identcode can be scanned and its contents can be recognized by querying a database (since the contents were already recorded online or at the first user terminal). In particular, the data record that is present can then be linked to further data or can be added to a new consignment data record.

The server comprises, for example, a system such as ARGUS and thus provides a platform for the exchange of customs information within the scope of MEDICI.

During the scanning of the freight bill, additional data may be acquired at the additional user terminal, for example, a pick-up date for the consignment. The input of such data is independent of whether the consignment or parts thereof are scanned at the additional user terminal.

Exemplary embodiments of the present invention relate to a method for processing data that is acquired for at least one consignment in a shipping system. The method according to an exemplary embodiment of the invention is characterized by the following steps:
acquiring data about the consignment at a first user terminal,
acquiring data about the consignment at an additional user terminal,
forwarding the data from the first user terminal and from the additional user terminal to a communication device that is connected to a server for processing the data,
processing the data from the first user terminal and from the additional user terminal by the server and, if applicable, returning the modified or unmodified data,
shipping processing of the consignment in an international exchange office.

In an exemplary embodiment of the method, it is provided for the data processed by the server to be subsequently forwarded to the communication device and, from there, if applicable via an interface, to at least an additional shipping system and/or to an additional data processing system.

The additional data processing system is, as already explained, for example, the national customs clearance system ATLAS or the international customs clearance system MEDICI.

By the same token, it is possible to transmit data from the interface to an additional data processing system that allows customs clearance that is adapted to the user such as, for instance, CURARE.

### BRIEF DESCRIPTION OF THE DRAWINGS

Exemplary embodiments of the present invention are described herein with reference to the accompanying drawings, without this restricting the general inventive idea in any way whatsoever.

The following is shown:

FIG. 1 is a block diagram of a shipping system for at least one consignment according to an exemplary embodiment of the present invention;

FIG. 2 is a block diagram of a shipping system according to an alternative exemplary embodiment of the present invention; and

FIG. 3 is a block diagram that is useful in explaining the operation of a shipping system according to an exemplary embodiment of the present invention.

### DETAILED DESCRIPTION OF SPECIFIC EMBODIMENTS

Data about a consignment is sent to a first user terminal (Term1) via a server account to a communication device (EDI-CC).

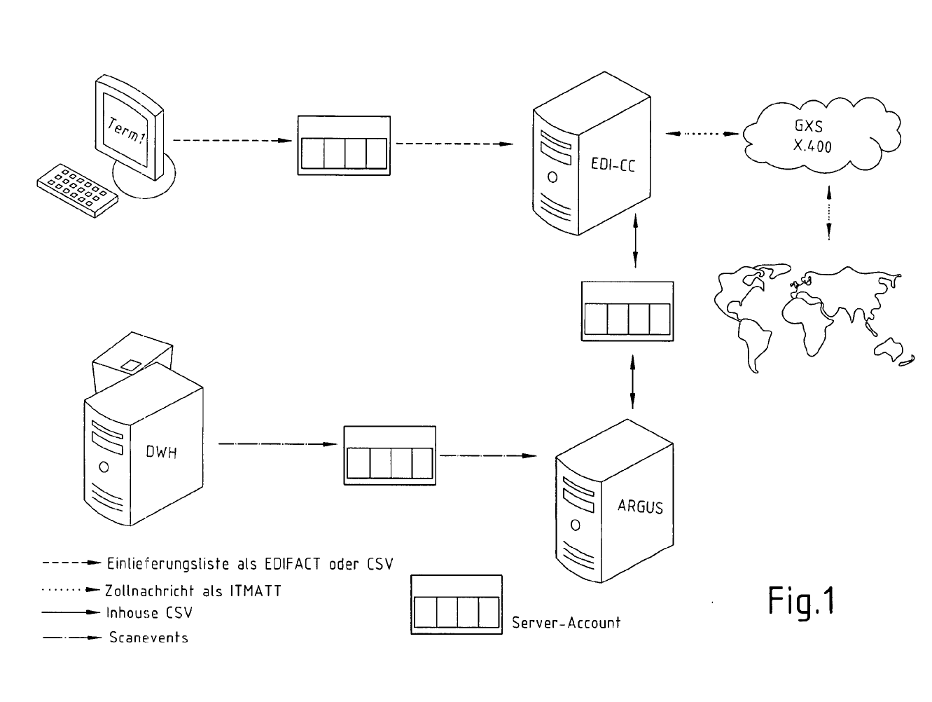

Independently in terms of time and place, a consignment—represented as a parcel in FIG. 1—which is partially concealed by the additional user terminal (TERM2), is delivered to a receiving station. The receiving station can be, for example, the branch office of a parcel service provider or a downstream parcel center where consignments are consolidated. The additional user terminal (TERM2) has a device for recording or scanning the freight bill that has been applied onto the consignment or else the encoded information that has been applied onto said freight bill or that has been applied elsewhere. Moreover, a pick-up and/or sending date for the consignment is entered at the additional user terminal (TERM2). Furthermore, specific consignment data can be acquired at the additional terminal.

The additional data received at the additional user terminal, i.e. if applicable, the pick-up and/or sending date as well as the scanned image or the acquired encoded information, is forwarded via a server account to a server, comprising a platform for the exchange of customs information (ARGUS).

In the example shown in FIG. 1, the data from the additional user terminal is not forwarded via the communication device (EDI-CC) but rather directly to the server (ARGUS). This variant is likewise conceivable and feasible within the scope of the invention.

The data at the first user terminal is forwarded in the form of a delivery list in the EDIFACT or CSV format, whereby other data formats are also conceivable. The communication between the communication device (EDI-CC) and the server (ARGUS) is carried out via an internally used data format (in-house CSV, whereby other data formats are also conceivable). The communication device (EDI-CC) has an interface (GXS) to at least one additional shipping system and/or to an additional data processing system, which is shown in FIG. 1 as a postal shipping system that operates worldwide.

Hence, FIG. 1 shows an expandable and flexible system that can be established and modified in harmony with an already existing infrastructure for message communication between shipping service providers and customs authorities, without these interventions entailing negative consequences for a user.

If data is acquired at the first user terminal via the filling-in of a CN 22 or CN 23 form, then subsequently the information is automatically transmitted to the communication device (EDI-CC). The first user terminal is connected, for example, via remote data transmission or other data transfer formats (e.g. GPRS, UMTS).

The server (ARGUS) comprises, for example, modules with which country-related collective messages as well as standard evaluations can be generated.

The advantage of the shipping system according to the invention also lies in the fact that the complete logics are integrated into the server (ARGUS) so that expansions and modifications to the system in terms of additional participants can be undertaken, without the need for a complex and labor-intensive manipulation of the logics of the system.

The communication device (EDI-CC) is of special significance in conjunction with the shipping system according to the invention since it establishes a connection between the data of the customs contents declarations, which is already present in the server (ARGUS) and which was entered at the first user terminal pertaining to a consignment, and the data received at the time when the consignment was physically dropped off at the additional user terminal, and thus, once the information has been received from both data sources, the remittal of customs-relevant goods information to a target system can be initiated in that this data is forwarded to a server (ARGUS).

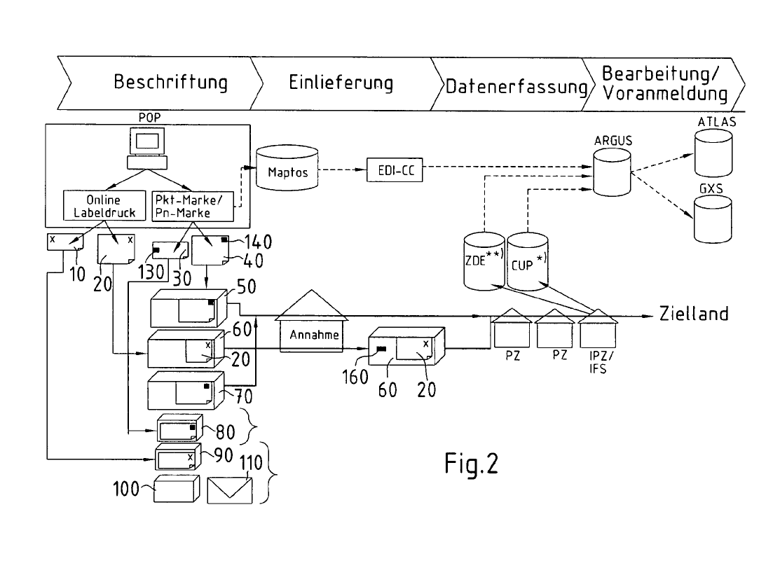

FIG. 2 shows a schematic diagram of an exemplary embodiment of the invention. Various modalities for acquiring the first data are depicted here. For example, the first data can be acquired in the area of a first terminal—preferably a user terminal POP. This first data is the data shown in this declaration, especially consignment data, customer data and customs data.

The first data is acquired by the user terminal POP. The acquisition is done, for example, using a program that allows a plausibility check as well as a completeness check, thus ensuring the completeness and data integrity of the first data.

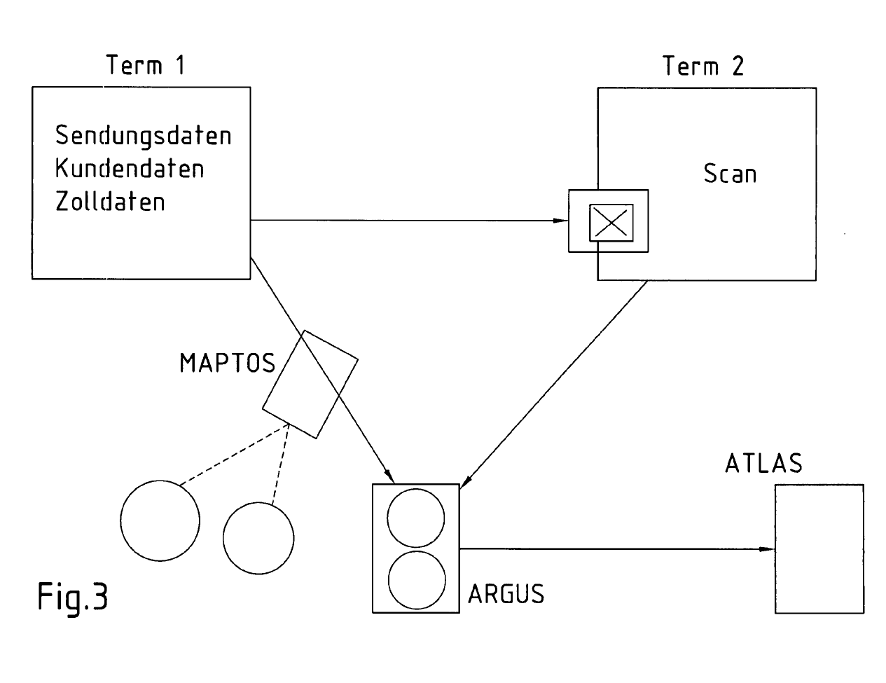

The terminal POP is one of the exemplary embodiments of the first terminal Term1 shown in FIGS. 1 and 3.

The user terminal POP allows the generation of online labels 10, 20 and package (Pkt) stamps 130 and parcel (Pn) stamps 140.

The stamps 130 and 140 are applied onto the consignments—for example, by adhesion.

Parcel codes (PN codes), like the Identcodes of the parcels, serve as identifiers of the mailpiece and are unambiguous. The difference with respect to the parcel identifiers is that this data can only be used internally and not for the customers for other purposes such as, for instance, shipment tracking.

First data about the consignment is acquired in the area of a first terminal Term1. This is, for example, consignment data, customer data or customs data.

The term consignment data is used to refer to all data that is relevant for describing the consignment. This includes: sender and recipient data, product and service designation, identifiers and, if applicable, additional encoded information (e.g. routing code).

Customer data encompasses all data that unambiguously identifies the customer (commissioning party) of the consignment. This can be done, for example, in the form of a customer number applied onto the consignment or by the sender's address (in the case of consignments of customers without customer numbers).

Customs data refers to all data that is required for the customs clearance. This includes classifications and descriptions of the contents of the consignment as well as of the value.

The logistics system comprises at least one network node. An exemplary network node is referred to below as MAPTOS.

However, it is not absolutely necessary for the system to be operated with a network node of the type described by MAPTOS. Rather, this is an advantageous embodiment.

The term MAPTOS refers to a network node or server for providing at least one service that is performed.

A refinement of the network node MAPTOS comprises at least one external connector for receiving a service request, whose generation can be initiated in a user computer of an Internet marketplace user, and for transmitting a processing result ascertained in the provider server to the user computer, whereby the external connector is capable of making a format change of the device request and of the processing result that has been adapted to the Internet marketplace.

Moreover, it may be advantageous to configure the network node in such a way that it has a transformation unit connected to the external connector for purposes of locating at least one server to perform the service on the basis of the information that is contained in the service request, and for purposes of addressing the service request to the located server.

A refinement of the network node comprises at least one internal connector connected to the transformation unit for transmitting the service request to the server and for receiving the processing result determined in the server from the server.

An exemplary embodiment of the invention comprises the forwarding of the acquired data.

The acquired data can be forwarded, for example, via a network node—especially the network node MAPTOS—or via a direct interface.

In each case, a point in time for the transmission is selected in accordance with the requirements. For example, the acquired data can be transmitted at the time when the mailpiece is dropped off.

In an exemplary embodiment of the invention, the network node MAPTOS forwards the first data to the additional server ARGUS.

If the consignments have been detected, then additional data—especially information about the detecting of the consignment—is forwarded to the server ARGUS.

The server ARGUS may be configured as a consolidation server. In particular, in a preferred refinement of the invention, it is configured in such a way that it can recognize and/or evaluate the arrival of the additional data as an event, and it can forward the first data and/or the additional data when the additional data arrives.

FIG. 3 shows a schematic depiction of an exemplary embodiment of the invention in which it is shown that consignment data, customer data and customs data are acquired as first data in the area of a first terminal.

The first data is transmitted in a manner that is physically connected to a consignment as well as electronically to a data processing unit MAPTOS—for example, a network node or a server. MAPTOS takes over the transmission of the data to an additional data processing unit ARGUS.

When the consignment is physically detected in the area of a second terminal TERM2, for example, as a scanning event of the consignment, the detection of the consignment and, if applicable, additional information about the consignment, are received as additional data and transmitted to the data processing unit ARGUS.

When the additional data arrives in the data processing unit ARGUS, the first data and, if applicable, also the additional data about the consignment are transmitted to an additional data processing unit ATLAS.

An exemplary embodiment of the invention comprises an additional data processing unit.

GXS stands for Global Exchange System and is a worldwide network for data transmission among various subscribers.

In the case of consignments whose consignment data has not already been acquired by a terminal—for example, one of the above-mentioned user terminals POP or a terminal in the area of a branch office of the logistics company—or at another detection location, for example, at an electronic parcel deposit box facility or a drop box—the acquisition of the consignment data takes place in a processing center for the consignments such as, for instance, a freight center FZ, a mail center PZ, in an international freight center IFZ (IFS) or in an international mail center IPZ.

For example, a central data acquisition ZDE takes place here. This can be done at all of the places that are suitable for clearing international consignments.

The recording of the consignments by the central data acquisition ZDE is shown by way of an example. The additional data is advantageously acquired by an additional data processing system CUP. This CUP system can detect (especially scan), for example, consignment codes, for instance, barcodes or data matrix codes, and can use them for the further handling of the consignment.

Here, it is possible to turn to an existing detection system (scanning system) as well as to an additional scanning system.

### LIST OF REFERENCE NUMERALS

Term1 first user terminal (e.g. Internet site, branch office terminal, acquisition terminal at a central data acquisition site)
TERM2 additional user terminal (e.g. in an international exchange location)
ARGUS server platform for the exchange of customs information
EDI-CC communication device
GXS interface to at least one additional shipping system and/or to an additional data processing system
ATLAS automated tariff and local customs clearance system (Germany)
MEDICI Mails Electronic Date Interchange & Customs Integration (international)
CURARE Customs Reorganization and Redesign

1-17. (canceled)

18. A shipping system for at least one consignment, comprising:
a first terminal for entering first data about the consignment;
a detector that is adapted to acquire further data about the consignment;
a consolidation server that stores, administers, processes and/or evaluates the first data, as desired;
a transmitter that is adapted to transmit the first data and the additional data to the consolidation server;
a checker that is adapted to determine whether the additional data about the consignment was received; and
a transmitter that is adapted to transmit the first data to a data recipient, the transmitter that is adapted to transmit the first data to the data recipient being configured so that it ascertains whether the additional data about the consignment was received so that the transmission of the first data only takes place once the additional data has been received.

19. The shipping system recited in claim 18, wherein the transmitter that is adapted to transmit the first data to the data recipient transmits the first data responsive to ascertaining that the additional data was received.

20. The shipping system recited in claim 18, comprising a communication device for receiving the first data.

21. The shipping system recited in claim 18, wherein the first terminal comprises a user terminal.

22. The shipping system recited in claim 18, wherein the first terminal comprises an automated acquisition terminal.

23. The shipping system recited in claim 18, comprising a printer that is adapted to print out the first data.

24. The shipping system recited in claim 18, comprising a storage medium connected to the consignment, the storage medium being adapted to store the first data.

25. The shipping system recited in claim 18, comprising:
a configuration of the consolidation server that also stores, administers, processes and/or evaluates the additional data, as desired; and
a communication device that is connected to the first user terminal, optionally with an additional user terminal and the server, and each time, it converts the data in such a way that the data of the first user terminal and, if applicable, the data of the additional user terminal as well as the data of the server are compatible with each other, the communication device or the server having an interface to at least one additional shipping system, to a network and/or to an additional data processing system.

26. The shipping system recited in claim 25, wherein the additional shipping system and/or the additional data processing system is a national or international customs clearance system (ATLAS, MEDICI).

27. The shipping system recited in claim 25, wherein the additional shipping system and/or the additional data processing system is a customs clearance system (CURARE) that is adapted to the user.

28. The shipping system recited in claim 18, wherein the data about the consignment comprises information about the sender and about the recipient as well as customs-relevant information.

29. The shipping system recited in claim 18, wherein the first user terminal provides an electronic form to be filled in by a user.

30. The shipping system recited in claim 18, comprising an additional user terminal for entering data about the consignment, the additional user terminal including a device for scanning or recording the consignment or parts thereof, especially a freight bill applied onto the consignment or else analog or digital information carriers placed onto or into the consignment.

31. A method for processing data that is generated in a shipping system for at least one consignment, the method comprising:
acquiring data about the consignment in at least a first user terminal;
accepting the consignment at a receiving station;
acquiring the data about the consignment at an additional user terminal;
forwarding the data from the first and, if applicable, from the additional user terminal to a communication device that is connected to a server for processing the data and
processing the data from the first user terminal and from the additional user terminal by the server.

32. The method recited in claim 31, wherein the data processed by the server is subsequently forwarded directly to the communication device and/or from there, if applicable, via an interface and via a data network to at least one additional data processing system.

33. The method recited in claim 31, wherein the additional shipping system and/or the additional data processing system is a national or international customs clearance system.

34. The method recited in claim 31, wherein the additional shipping system and/or the additional data processing system is a customs clearance system that is adapted to the user.

35. A shipping system for at least one consignment, comprising:
a first terminal for entering the first data about the consignment;
a detection means for acquiring further data about the consignment;
a consolidation server that stores, administers, processes and/or evaluates the first data, as desired;
means for transmitting the first data to the consolidation server;
means for transmitting the additional data to the consolidation server;
means for checking whether the additional data about the consignment was received; and
means for transmitting the first data to a data recipient, whereby the means for transmitting the first data to the data recipient is configured in such a way that it ascertains whether the additional data about the consignment was received so that the transmission of the first data only takes place once the additional data has been received.
